(19) United States
(12) Patent Application Publication
(10) Pub. No.: US 2010/0191981 A1
(43) Pub. Date: Jul. 29, 2010

(54) STORAGE APPARATUS AND DATA FALSIFICATION PREVENTING METHOD THEREOF

(75) Inventor: Masaki OBUCHI, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/692,523

(22) Filed: Jan. 22, 2010

(30) Foreign Application Priority Data
Jan. 23, 2009 (JP) 2009-013246

(51) Int. Cl. G06F 12/14; H04L 9/06

(52) U.S. Cl. 713/189; 380/44

(57) ABSTRACT

According to one embodiment, a storage apparatus includes: an encryption key generation information generator configured to generate encryption key generation information used to generate an encryption key based on information from a host computer; an encryption key generator configured to generate the encryption key based on the encryption key generation information; an initialization data encryption module configured to encrypt initialization data of a storage medium received from the host computer using the encryption key; a decryption module configured to decrypt data read from the storage medium using a decryption key corresponding to the encryption key; a comparator configured to compare data decrypted by the decryption module and the initialization data; and a write processor configured to permit, when the comparator determines that the data decrypted by the decryption module and the initialization data match with each other, to write user data in the storage medium.

### CROSS-REFERENCE TO RELATED APPLICATIONS

This application is based upon and claims the benefit of priority from Japanese Patent Application No. 2009-013246, filed on Jan. 23, 2009, the entire contents of which are incorporated herein by reference.

### BACKGROUND

1. Field

One embodiment of the invention relates to a storage apparatus having a data falsification preventing function, and a data falsification preventing method thereof.

2. Description of the Related Art

In general, in storage apparatuses that store data in storage media, it is important to maintain security of data because serious trouble is caused when data is falsified by a malicious third person. Hence, for example, various methods such as a method for permitting writing or updating data when a valid password is input, are devised.

Japanese Patent Application Publication (KOKAI) No. 2005-027202, Japanese Patent Application Publication (KOKAI) No. 2006-309298, Japanese Patent Application Publication (KOKAI) No. 2006-031396, and Japanese Patent Application Publication (KOKAI) No. H11-149414 disclose technologies for maintaining the security of data. For example, a method where a user has access to data in a storage medium using a keyword and a password or an encryption key generated on the basis of the password is devised. According to the method, when the user has the access to the data in the storage medium, it is required to input the keyword and the password or the password according to a generation count of the encryption key, thereby security of data can be improved using the encryption key generated on the basis of the keyword and the password or the password.

In another exemplary method of the technologies, a user ID and a password are set to a formatted storage medium, an encryption key of each user ID is generated using the set user ID and password, and data is encrypted using the generated encryption key when the data is written in the storage medium.

In still another exemplary method of the technologies, in a storage apparatus controlling a write count of data, a format count is limited to a rewrite count smaller than an upper limit of a rewrite count of the storage medium, thereby rewrite of data by a malicious third person or data erase by format is reduced.

However, in the aforementioned technologies, if the password leaks, data may be able to be falsified or erased. Therefore, it becomes necessary to severely manage the password. That is to say, since the writing or the updating of data is permitted by only the password, the security is insufficient with respect to the malicious third person in regards to security of data on the storage medium of the storage apparatus.

Further, conventionally, since a storage area for storing a user ID or a password and medium access permission information needs to be provided in the storage apparatus, a cost for securing the storage area and a risk of data falsification in the storage area are increased.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram of a write operation (format mode) for generating a write-once state according to an embodiment of the invention;

FIG. 2A is an exemplary diagram of a verification in a write-once mode in the embodiment;

FIG. 2B is an exemplary diagram of a first writing after a password is verified in the write-once mode in the embodiment;

FIG. 2C is an exemplary diagram a second and following writings after the password is verified in the write-once mode in the embodiment;

FIG. 3A is an exemplary diagram illustrating a generation of encryption key generation information that comprises format information in the embodiment;

FIG. 3B is another exemplary diagram illustrating a generation of encryption key generation information that does not comprise format information in the embodiment;

FIG. 4 is an exemplary block diagram of a magnetic disk apparatus in the embodiment;

FIG. 5 is an exemplary block diagram of a HDC in the embodiment;

FIG. 6 is an exemplary flowchart of a format process in the embodiment; and

FIG. 7 is an exemplary flowchart of a write-once verification in the embodiment.

### DETAILED DESCRIPTION

Various embodiments according to the invention will be described hereinafter with reference to the accompanying drawings. In general, according to one embodiment of the invention, a storage apparatus comprises: an encryption key generation information generator configured to generate encryption key generation information used to generate an encryption key, based on information from a host computer; an encryption key generator configured to generate the encryption key based on the encryption key generation information; an initialization data encryption module configured to encrypt initialization data of a storage medium received from the host computer using the encryption key; a decryption module configured to decrypt data read from the storage medium using a decryption key corresponding to the encryption key; a comparator configured to compare data decrypted by the decryption module and the initialization data; and a write processor configured to permit, when the comparator determines that the data decrypted by the decryption module and the initialization data match with each other, to write user data in the storage medium.

According to another embodiment of the invention, a data falsification preventing method of a storage apparatus, comprises: first generating encryption key generation information used to generate an encryption key, based on information from a host computer; second generating the encryption key based on the encryption key generation information; encrypting initialization data of a storage medium received from the host computer using the encryption key; decrypting data read from the storage medium using a decryption key corresponding to the encryption key; comparing data decrypted by the decrypting and the initialization data; and permitting, when it is determined by the comparing that the data decrypted by the decrypting and the initialization data match with each other, to write user data in the storage medium.

A storage apparatus that is illustrated in a following embodiment is a magnetic disk apparatus that uses a magnetic disk as a storage medium. However, the embodiment is not limited thereto, and the storage apparatus may be a storage apparatus of a different type, such as an optical disk apparatus, a magneto-optical disk apparatus, a thermo-magnetic disk apparatus, and a nonvolatile semiconductor memory.

In the following embodiment, data is written to the magnetic disk by a sector, but may be written to the magnetic disk by plural sectors or tracks comprised between adjacent servo information. In the following embodiment, the “corresponding sector” represents an area of the magnetic disk where data is to be written.

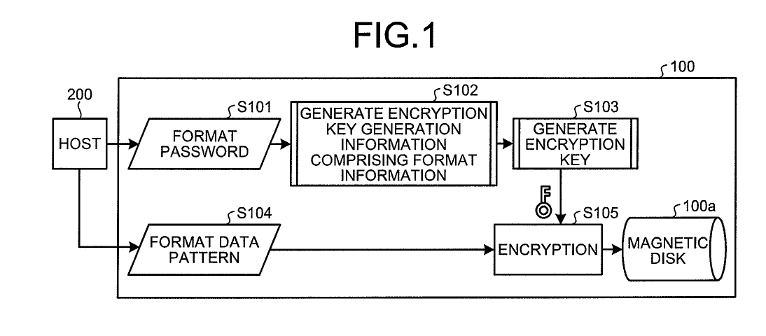

FIG. 1 illustrates the outline of a write operation (format mode) for generating a write-once state according to the embodiment of the invention. Specifically, FIG. 1 illustrates the outline of the operation for generating the write-once state in which data is permitted to be written once for each sector after a magnetic disk 100a of a magnetic disk apparatus 100 according to the embodiment is formatted.

As illustrated in FIG. 1, the magnetic disk apparatus 100 receives a password input by a user from a host computer (host) 200 (S101). In this case, the password (format password) is a password at the time of a format that is needed to format the magnetic disk 100a of the magnetic disk apparatus 100.

Next, the magnetic disk apparatus 100 generates encryption key generation information that comprises format information (S102). The format information (for example, flag information) indicates whether the encryption key generation information is information of when the magnetic disk 100a is formatted.

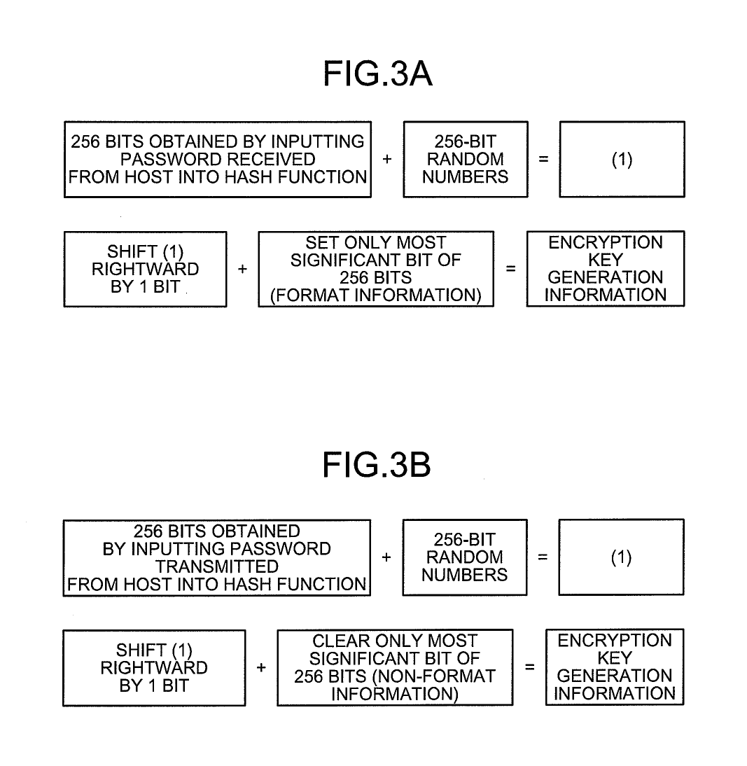

The encryption key generation information that comprises the format information is generated as illustrated in FIG. 3A. In FIG. 3A, the format password received from the host 200 is first input into a hash function, and 256-bit data is obtained. The result obtained by adding 256-bit random numbers to the 256-bit data is called (1).

A result obtained by shifting (1) rightward by 1 bit is the 256-bit data. A most significant bit of the 1-bit-shifted data is set to “1”. Here, the most significant bit of “1” is the format information. The 256-bit data in which the most significant bit is set to “1” is the encryption key generation information that comprises the format information.

Referring back to FIG. 1, the magnetic disk apparatus 100 generates an encryption key using the encryption key generation information that comprises the format information generated in S102 (S103). Meanwhile, the magnetic disk apparatus 100 receives a data pattern at the time of the format (format data pattern) from the host 200 (S104).

Next, the magnetic disk apparatus 100 encrypts the format data pattern using the encryption key generated in S103 (S105). Meanwhile, the magnetic disk apparatus 100 formats the entire magnetic disk 100a using the encrypted format data pattern.

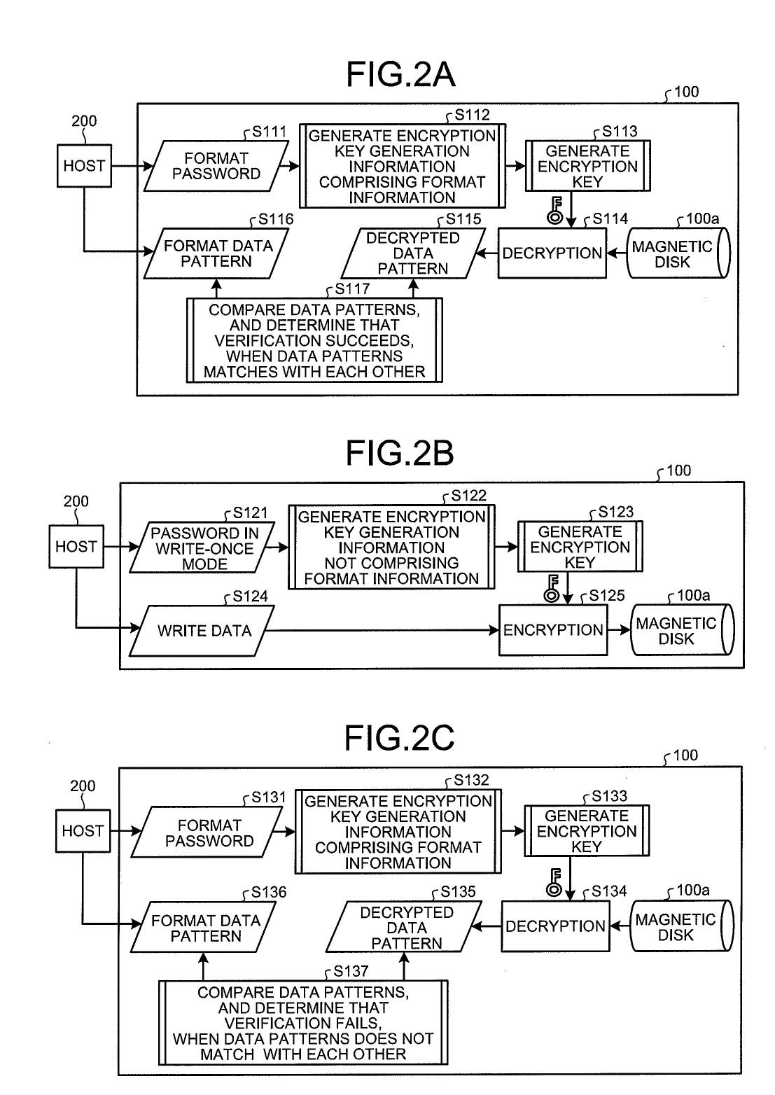

FIG. 2A illustrates the outline of an operation (verification) in the write-once mode according to the embodiment. Specifically, FIG. 2A illustrates the outline of a verification to permit writing data into the magnetic disk 100a of the magnetic disk apparatus 100 according to the embodiment.

As illustrated in FIG. 2A, the magnetic disk apparatus 100 receives the format password input by the user, which is the same as that illustrated in FIG. 1, from the host 200 (S111). Next, the magnetic disk apparatus 100 generates the encryption key generation information comprising the format information, similar to S102 of FIG. 1 (S112).

Next, as similar to S102, the magnetic disk apparatus 100 generates the encryption key and a decryption key corresponding to the encryption key, using the encryption key generation information comprising the format information generated in S112 (S113).

Next, the magnetic disk apparatus 100 reads data from a data written sector of the magnetic disk 100a, and decrypts the data using the encryption key generated in S113 (S114). By executing the process of S114, a decrypted data pattern is obtained (S115).

Meanwhile, the magnetic disk apparatus 100 receives the format data pattern from the host computer 200 (S116). Next, the magnetic disk apparatus 100 compares the data pattern decrypted in S115 and the format data pattern received in S116 (S117).

When the decrypted data pattern and the format data pattern matches with each other as a result of the comparison in S117, the verification succeeds. When the verification succeeds, the host 200 is permitted to write data in the magnetic disk 100a of the magnetic disk apparatus 100.

On the other hand, when the decrypted data pattern and the format data pattern does not match with each other as a result of the comparison in S117, or in other words, when the verification fails, the format password received from the host 200 is different, the format data pattern received from the host 200 is different, or the data is already written in the corresponding sector in the write-once mode.

FIG. 2B illustrates the outline of an operation (first writing after a password is verified) in a write-once mode according to the embodiment. Specifically, FIG. 2B illustrates the outline of an operation of when data is first written in the magnetic disk 100a after the format, in the magnetic disk 100a of the magnetic disk apparatus 100 according to the embodiment.

As illustrated in FIG. 2B, the magnetic disk apparatus 100 receives the password in the write-once mode input by the user, which is the same as that illustrated in FIG. 1, from the host 200 (S121). Next, the magnetic disk apparatus 100 generates the encryption key generation information that does not comprise the format information (S122).

The encryption key generation information that does not comprise the format information is information that is generated as illustrated in FIG. 3B. In FIG. 3B, the format password received from the host 200 is first input into a hash function, and 256-bit data is obtained. A result obtained by adding 256-bit random numbers to the 256-bit data is called (1).

A result obtained by shifting (1) rightward by 1 bit is the 256-bit data. A most significant bit of the 1-bit-shifted data is set to “0”. The most significant bit of “0” corresponds to the case where the format information is not comprised. The 256-bit data with the most significant bit of “0” is the encryption key generation information that does not comprise the format information.

Referring back to FIG. 2B, the magnetic disk apparatus 100 generates an encryption key, using the encryption key generation information not comprising the format information generated in S122 (S123). Meanwhile, the magnetic disk apparatus 100 receives write data from the host 200 (S124).

Next, the magnetic disk apparatus 100 encrypts the write data using the encryption key generated in S123 (S125). The magnetic disk apparatus 100 writes the encrypted write data in the corresponding sector of the magnetic disk 100a.

FIG. 2C illustrates the outline of an operation (second and following writings after a password is verified) in the write-once mode according to the embodiment. Specifically, FIG. 2C illustrates the outline of the operation of when verification is performed to further write data after data is already written in the magnetic disk 100a of the magnetic disk apparatus 100 according to the embodiment.

S131 to S137 in FIG. 2C correspond to S111 to S117 illustrated in FIG. 2A. However, as the result of comparison in S117, the decrypted data pattern and the format data pattern are determined to match with each other, so that the verification succeeds. Meanwhile, as a result of comparison in S137, the decrypted data pattern and the format data pattern does not match with each other, so that the verification fails. That is, since the verification fails, the host 200 is not permitted to write data in the magnetic disk 100a of the magnetic disk apparatus 100.

The reason why the encryption key generation information at the time of the format and the encryption key generation information at the time of writing the data are separated by the encryption key generation information comprising the format information and the encryption key generation information not comprising the format information is as follows.

A case in which the same encryption key generation information is used at the time of the format and at the time of writing data is considered. As illustrated in FIG. 2C, when the verification is performed to further write data after data is already written in the magnetic disk 100a while the same encryption key is used, the write data might accidentally matches with the format data pattern. Therefore, by using the different encryption key generation information, the decrypted data pattern and the format data pattern can be prevented from being matched with each other in the aforementioned case.

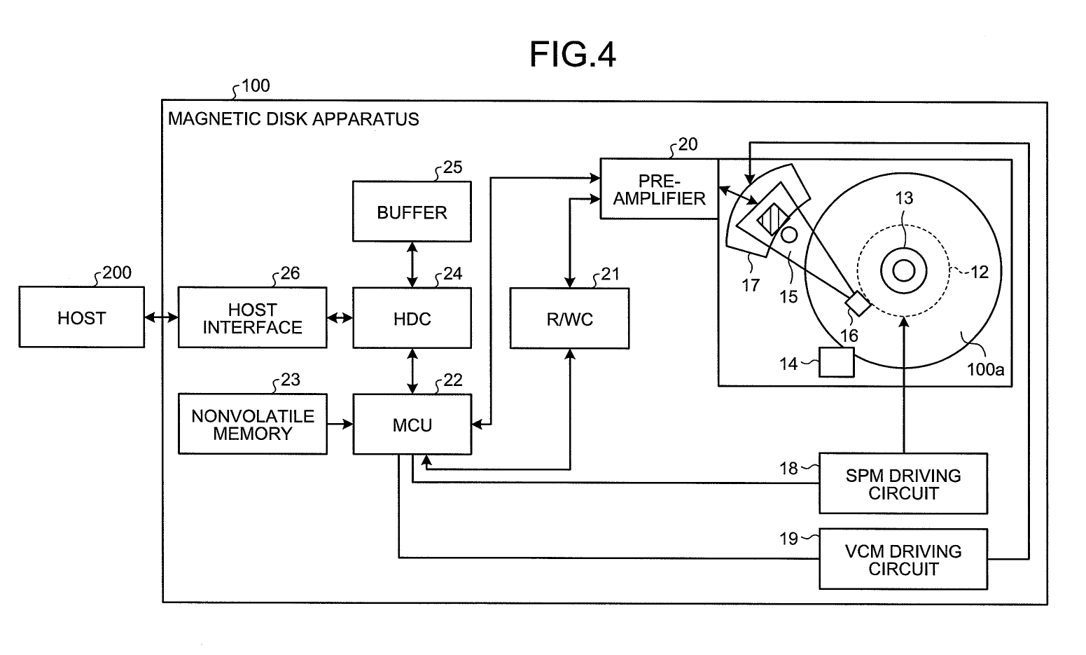

FIG. 4 is a block diagram of a configuration of the magnetic disk device according to the embodiment. As illustrated in FIG. 4, the magnetic disk apparatus 100 according to the embodiment comprises the magnetic disk 100a, a spindle motor (SPM) 12 that rotates the magnetic disk 100a about a rotation shaft, an inner stopper 13, an outer stopper 14, a head actuator 15, a magnetic head 16 that is mounted on a front end of the head actuator 15, and a voice coil motor (VCM) 17.

The magnetic disk apparatus 100 further comprises an SPM driving circuit 18 that drives the SPM 12 and a VCM driving circuit 19 that drives the VCM 17. The magnetic disk apparatus 100 further comprises a preamplifier 20 that amplifies a signal read from the magnetic disk 100a and a signal written in the magnetic disk 100a by the magnetic head 16, and a read/write channel (R/WC) 21 that encodes information written in the magnetic disk 100a and decodes the signal read from the magnetic disk 100a.

The magnetic disk apparatus 100 further comprises a micro controller unit (MCU) 22 that controls the magnetic disk apparatus and a nonvolatile memory 23 that is connected to the MCU 22 and can rewrite data. The magnetic disk apparatus 100 further comprises a hard disk controller (HDC) 24 that corrects an error of data exchanged between the magnetic disk apparatus 100 and the host 200, a buffer 25 that buffers data exchanged between the HDC 24 and the host 200, and a host interface 26 that is a connection interface with the host 200.

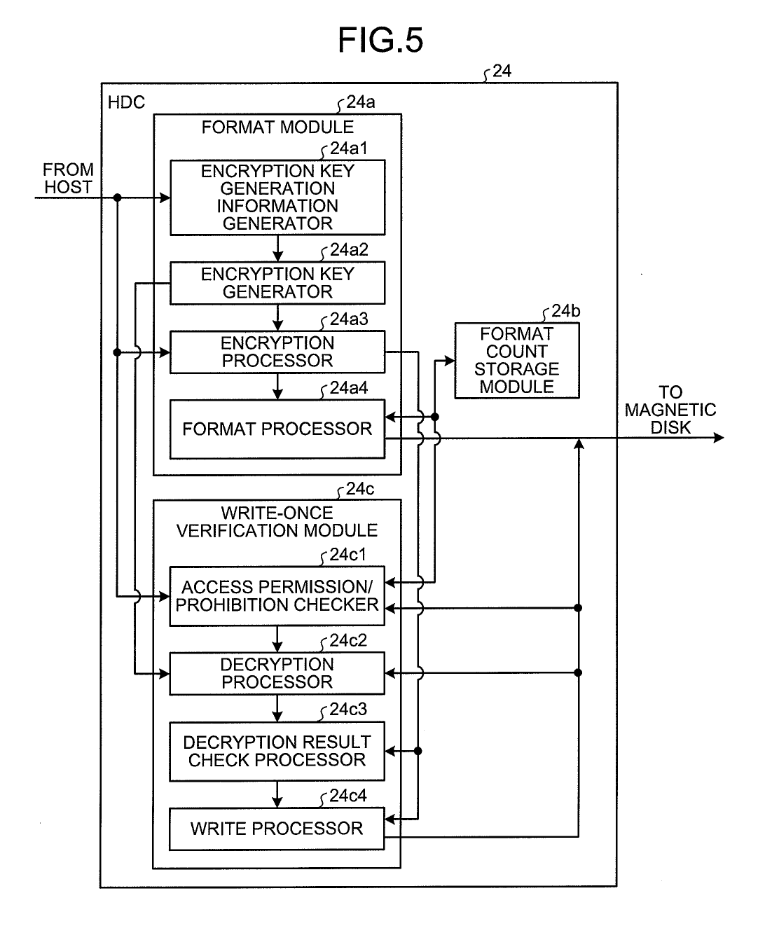

FIG. 5 is a functional block diagram of a configuration of the HDC according to the embodiment. In the embodiment, the processes that are illustrated in FIGS. 1 and 2A to 2C are executed by the HDC 24 in hardware wise.

As illustrated in FIG. 5, the HDC 24 has a format module 24a, a format count storage module 24b, and a write-once verification module 24c. The format module 24a is a functional module that performs the format to generate a write-once state in the magnetic disk 100a. The format count storage module 24b stores a format count of the magnetic disk 100a by the format module 24a and an upper limit of the format count.

The write-once verification module 24c performs the verification that is schematically illustrated in FIGS. 2A and 2C. When the verification succeeds, the write-once verification module 24c permits the host 200 to write the data to the magnetic disk 100a. When the verification fails, the write-once verification module 24c prohibits the host 200 to write the data to the magnetic disk 100a.

The format module 24a has an encryption key generation information generator 24a1, an encryption key generator 24a2, an encryption processor 24a3, and a format processor 24a4. When the format of the magnetic disk 100a and the verification are performed, the encryption key generation information generator 24a1 generates the encryption key generation information comprising the format information from the arbitrary password received from the host 200. When the data is written in the magnetic disk 100a, the encryption key generation information generator 24a1 generates the encryption key generation information not comprising the format information from the password, which is received from the host 200 and used at the time of the format.

The encryption key generator 24a2 generates the encryption key from the encryption key generation information comprising the format information generated by the encryption key generation information generator 24a1. The encryption key generator 24a2 generates only the encryption key when the magnetic disk 100a is formatted. However, when the data is written in the magnetic disk 100a, the encryption key generator 24a2 generates the encryption key and the decryption key corresponding to the encryption key.

The encryption processor 24a3 encrypts the format data pattern received from the host 200, using the encryption key generated by the encryption key generator 24a2. The format processor 24a4 refers to the format count that is stored in the format count storage module 24b. When the format count indicates that the format is performed for the first time (that is, the format count is 0), the format processor 24a4 permits the format of the magnetic disk 100a. The format processor 24a4 formats the magnetic disk 100a with the encrypted format data pattern. The format processor 24a4 adds 1 to the format count stored in the format count storage module 24b.

The upper limit of the format count is also stored in the format count storage module 24b. When the format of the magnetic disk 100a is allowed many times, the format processor 24a4 checks whether the format count is equal to the upper limit of the format count, in order to prevent the format count from exceeding the upper limit of the format count by the current format. When the format count is equal to the upper limit of the format count, the format processor 24a4 prohibits the format of the magnetic disk 100a.

The write-once verification module 24c has an access permission/prohibition checker 24c1, a decryption processor 24c2, a decryption result check processor 24c3, and a write processor 24c4. The access permission/prohibition checker 24c1 refers to the format count storage module 24b to determine whether the format count reaches the upper limit of the format count.

When it is determined that the format count does not reach the upper limit of the format count, the decryption processor 24c2 decrypts the data read from the corresponding sector of the magnetic disk 100a. The decryption key used in the decryption is that corresponds to the encryption key generated by the encryption key generation information generator 24a1 using the encryption key generation information comprising the format information.

The decryption result check processor 24c3 compares the format data pattern encrypted by the encryption processor 24a3 and the data of the corresponding sector of the magnetic disk decrypted by the decryption processor 24c2. When the format data pattern and the data of the corresponding sector match with each other, the decryption result check processor 24c3 can determine that data is not yet written in the corresponding sector. Therefore, the decryption result check processor 24c3 permits the write processor 24c4 to write data in the magnetic disk 100a.

If the write of the data is permitted, the write processor 24c4 writes the data encrypted using the encryption key based on the encryption key generation information not comprising the format information in the corresponding sector of the magnetic disk 100a.

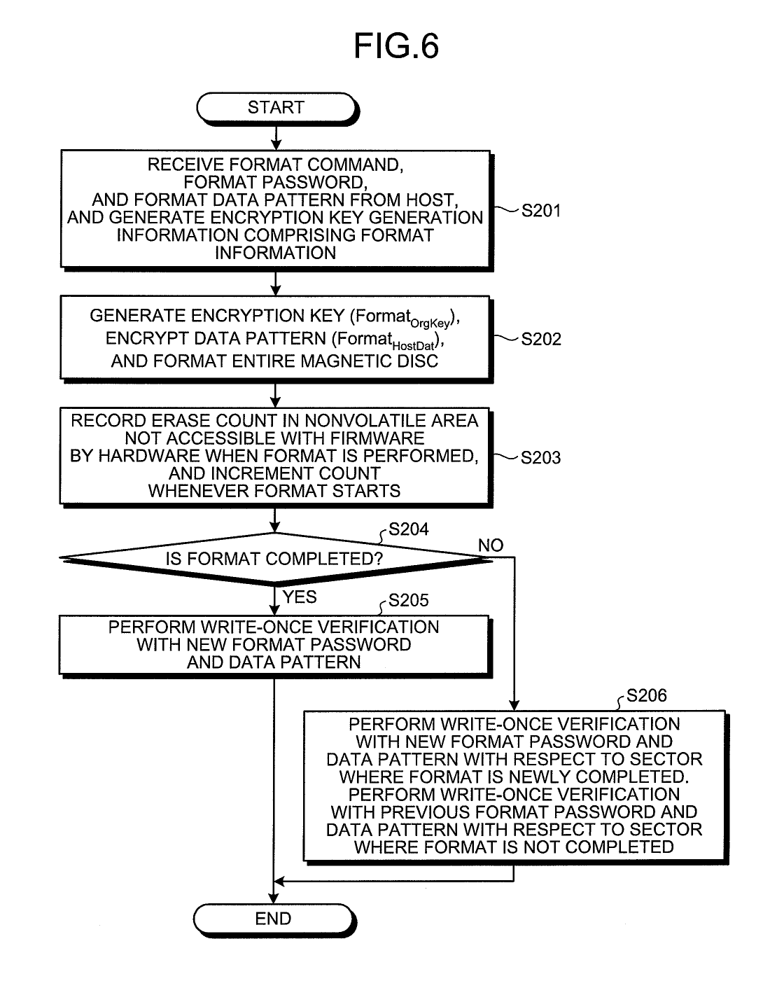

FIG. 6 is a flowchart illustrating a format process according to the embodiment. As illustrated in FIG. 6, first, in S201, the encryption key generation information generator 24a1 receives the arbitrary format password and the format data pattern from the host 200. The encryption key generation information generator 24a1 generates the encryption key generation information comprising the format information, using the method illustrated in FIG. 3A (S201).

Next, in S202, the encryption key generator 24a2 generates the encryption key (Format_{OrgKey}) using the encryption key generation information comprising the format information generated in S201. The encryption processor 24a3 encrypts the format data pattern (Format_{HostDat}) received from the host 200. The format processor 24a4 formats the entire surface of the magnetic disk 100a (S202).

Next, in S203, the format processor 24a4 adds 1 to the format count stored in the predetermined storage area of the format count storage module 24b. Here, only the format processor 24a4 and the access permission/prohibition checker 24c1 can access to the format count storage module 24b, and the firmware of the magnetic disk apparatus 100 cannot access to the format count storage module 24b. The process of adding 1 to the format count is executed whenever the format is performed, as long as the format count does not exceed the upper limit of the format count.

Next, in S204, the format processor 24a4 determines whether the format is completed. When it is determined that the format is completed (Yes at S204), the format processor 24a4 proceeds to S205. When it is determined that the format is not completed (No at S204), the format processor 24a4 proceeds to S206.

In S205, the write-once verification module 24c can perform the write-once verification using the format password and the data pattern received in S201.

Meanwhile, in S206, in the sector of the magnetic disk 100a where the format is completed, the write-once verification module 24c can perform the write-once verification using the format password and the data pattern received in S201.

Further, in S206, in the sector of the magnetic disk 100a where the format is not completed, the write-once verification module 24c can perform the write-once verification using the format password and the data pattern received at the time of the previous format.

In other words, the areas of the magnetic disk 100a can be logically divided so as to format each areas by different passwords, and the write-once function can be realized for each area. As a result, security of the write-once function that is realized in the embodiment may be improved. Since the individual write-once function can be shared with one magnetic disk 100a between the users, convenience of the magnetic disk 100a may be improved.

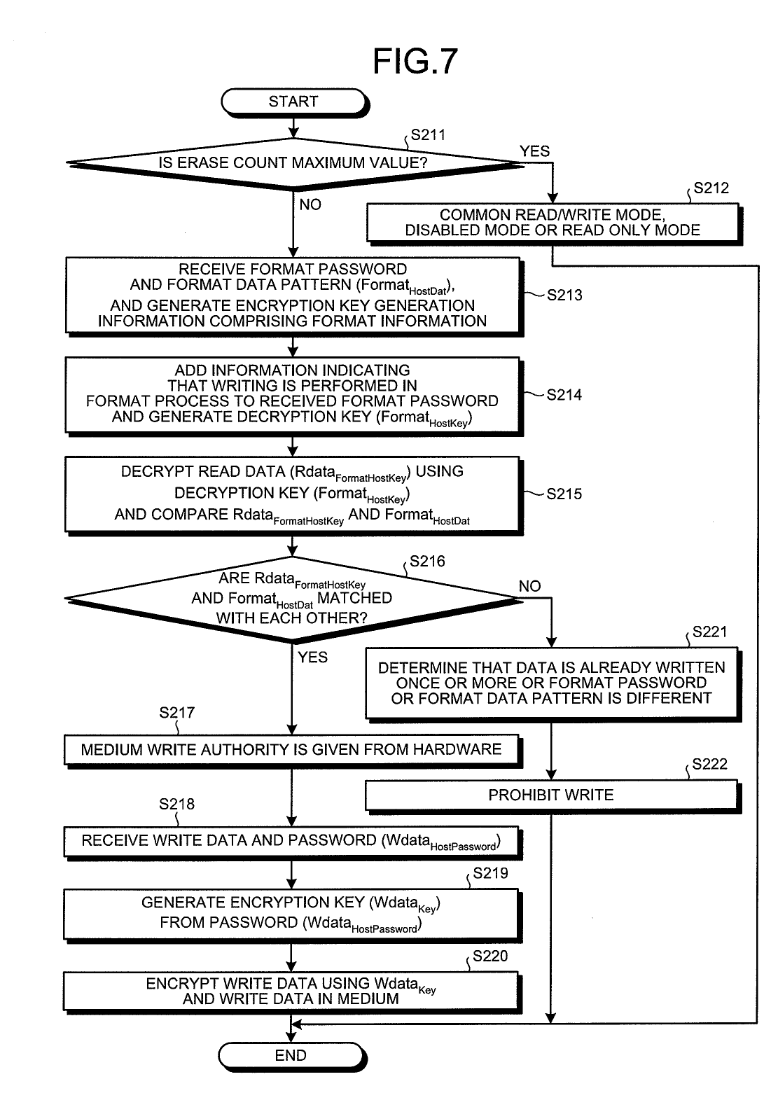

FIG. 7 is a flowchart illustrating a write-once verification process according to the embodiment. As illustrated in FIG. 7, first, in S211, the format processor 24a4 refers to the format count storage module 24b to determine whether the format count (erase count) reaches the upper limit (maximum value) of the format count. When it is determined that the format count reaches the upper limit of the format count (Yes at S211), the format processor 24a4 proceeds to S212. When it is determined that the format count does not reach the upper limit of the format count (No at S211), the format processor 24a4 proceeds to S213. In S212, the magnetic disk 100a proceeds to an appropriate access mode, such as a common read/write mode, a disabled mode or a read only mode. If the process is completed, the write-once verification process ends.

In S213, the encryption key generation information generator 24a1 receives the format password used in the format and the format data pattern (Format_{HostDat}) from the host 200. The encryption key generation information generator 24a1 generates the encryption key generation information comprising the format information, using the method illustrated in FIG. 3A (S213).

Next, in S214, the encryption key generator 24a2 generates the decryption key (Format_{HostKey}) corresponding to the encryption key (Format_{OrgKey}) using the encryption key generation information comprising the format information generated in S213.

Next, in S215, the decryption processor 24c2 decrypts the read data (Rdata_{FormatHostKey}) that is read from the magnetic disk 100a. The decryption processor 24c2 compares the read data (Rdata_{FormatHostKey}) and the format data pattern (Format_{HostDat}) (S215).

In S216, the decryption result check processor 24c3 determines whether the read data and the data pattern match with each other as the result of comparison in S215. When it is determined that the read data and the data pattern match with each other (Yes at S216), the decryption result check processor 24c3 proceeds to S217. When it is determined that the read data and the data pattern does not match with each other (No at S216), the decryption result check processor 24c3 proceeds to S221.

In S217, the decryption result check processor 24c3 permits the write processor 24c4 to write the data in the magnetic disk 100a. Next, in S218, the encryption key generation information generator 24a1 receives the write data and the arbitrary password (Wdata_{Hostpassword}) for data write, from the host 200.

Next, in S219, the encryption key generator 24a2 generates an encryption key (Wdata_{Key}) from the password (Wdata_{HostPassword}). Next, in S220, the encryption processor 24a3 encrypts the write data using the encryption key (Wdata_{Key}). The write processor 24c4 writes the encrypted write data in the corresponding sector of the magnetic disk 100a (S220). If the process is completed, the write-once verification process ends.

Meanwhile, in S221, the decryption result check processor 24c3 determines that the data is already written once or more in the formatted area of the magnetic disk 100a or the format password used in the format and/or the format data pattern (Format_{HostDat}) is erroneous. Next, in S222, the decryption result check processor 24c3 prohibits the write processor 24c4 from writing data in the magnetic disk 100a. When the process is completed, the write-once verification process ends.

As described above, in the embodiment, the entire storage area of the storage medium is initialized with the encrypted initialization data, and the user data is written in the storage medium when the data obtained by decrypting the data read from the storage medium using the decryption key corresponding to the encryption key and the initialization data match with each other. Therefore, the write-once function of the storage medium can be realized without using the storage area for storing the information to generate the encryption key.

Further, in the storage apparatus and the data falsification preventing method thereof according to the embodiment, regards to security of data on the storage medium of the storage apparatus, a high security can be secured with respect to the malicious third person, and a risk of data falsification in the storage area can be prevented.

All or part of the processes that are described as being automatically executed among the processes described in the embodiment may be manually executed, or all or part of the processes that are described as being manually executed may be automatically executed using a known method. In addition, the process, the control sequences, the specific names, and the information including the variety of data or parameters that are illustrated in the embodiment may be arbitrarily changed, except for the case where special mentions are given.

The components of the individual apparatus that are illustrated in the drawings are functional and conceptual, and do not need to be physically configured as illustrated in the drawings. That is, the specific forms of separation and/or integration of the apparatuses and the storage units are not limited to the forms illustrated in the drawings. All or part of the apparatuses may be configured to be functionally or physically separated and/or integrated in an arbitrary unit according to the various loads or use situations.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage apparatus, comprising:
an encryption key generation information generator configured to generate encryption key generation information used in generating an encryption key, based on information from a host computer;
an encryption key generator configured to generate the encryption key based on the encryption key generation information;
an initialization data encryption module configured to encrypt initialization data of a storage medium with the encryption key, the initialization data being entered at the host computer;
a decryption module configured to decrypt data from the storage medium with a decryption key corresponding to the encryption key;
a comparator configured to compare decrypted data and the initialization data; and
a writer configured to write user data in the storage medium when the comparator determines that the decrypted data and the initialization data match with each other.

2. The storage apparatus of claim 1, further comprising an initialization module configured to initialize an entire storage area of the storage medium with the encrypted initialization data.

3. The storage apparatus of claim 1, wherein the encryption key generation information comprises initialization information indicating initialization of the storage medium.

4. The storage apparatus of claim 1, wherein the encryption key generation information does not comprise the initialization information.

5. The storage apparatus of claim 1, wherein the decryption module is configured to read data by a data manager in the storage medium.

6. The storage apparatus of claim 1, further comprising:
an initialization count storage module configured to store an initialization count indicating a number of times the storage medium has been initialized by the initialization module,
wherein the initialization count in the initialization count storage module is rewritten by the initialization module.

7. The storage apparatus of claim 6, further comprising:
an initialization count checker configured to check the initialization count,
wherein the initialization count checker is configured to prohibit the writer from writing the user data in the storage medium when the initialization count exceeds a predetermined limit.

8. The storage apparatus of claim 7,
wherein the host computer is configured to store an initialization instruction count indicating a number of times the storage medium has been initialized by the initializing module according to an instruction of the host computer in a predetermined storage area, and
the initialization count checker is configured to prohibit, the writer from writing the user data in the storage medium, when the initialization instruction count in the host computer and the initialization count in the initialization count storage module does not match with each other.

9. The storage apparatus of claim 1, further comprising:
an input information checker configured to check the input information,
wherein the input information checker is configured to prohibit the writer from writing the user data in the storage medium when the input information is invalid.

10. A data protection method of a storage apparatus, comprising:
first generating encryption key generation information used in generating an encryption key, based on information from a host computer;
second generating the encryption key based on the encryption key generation information;
encrypting initialization data of a storage medium entered at the host computer with the encryption key;
decrypting data from the storage medium with a decryption key corresponding to the encryption key;
comparing decrypted data and the initialization data; and
writing user data in the storage medium when it is determined in the comparing that the decrypted data and the initialization data match with each other.

11. The data protection method of claim 10, further comprising initializing an entire storage area of the storage medium with the encrypted initialization data.

12. The data protection method of claim 10, wherein the encryption key generation information comprises initialization information indicating initialization of the storage medium.

13. The data protection method of claim 10, wherein the encryption key generation information does not comprise the initialization information.
